(19) United States
(12) Patent Application Publication
(10) Pub. No.: US 2016/0039195 A1
(43) Pub. Date: Feb. 11, 2016

(54) FORME CYLINDER FOR A SHEET-FED ROTARY PRINTING PRESS FOR THE PRODUCTION OF BANKNOTES AND LIKE SECURITIES

(71) Applicant: KBA-NOTASYS SA, Lausanne 22 (CH)

(72) Inventor: Johannes Georg SCHAEDE, Würzburg (DE)

(73) Assignee: KBA-NOTASYS SA, Lausanne 22 (CH)

(21) Appl. No.: 14/773,651

(22) PCT Filed: Mar. 7, 2014
(86) PCT No.: PCT/IB2014/059521

§ 371 Date: Sep. 8, 2015

(30) Foreign Application Priority Data
Mar. 7, 2013 (EP) 13158269.4

(51) Int. Cl. B41F 11/02

(52) U.S. Cl. CPC B41F 11/02

(57) ABSTRACT

There is described a sheet-fed rotary printing press (100; 200; 300) for the production of banknotes and like securities comprising at least one printing form cylinder (115, 125; 215; 315, 325) having one or more segments. A nominal diameter (D) of the at least one printing form cylinder (115, 125; 215; 315, 325) substantially corresponds to an integer multiple of a reference diameter of a one-segment cylinder (103a; 103c; . . . ) as used for printing onto super-format sheets exhibiting a standardized format with a width of the order of 820 mm and a length of the order of 700 mm. An axial length (AL) of the at least one printing form cylinder (115, 125; 215; 315, 325) is comparatively greater than a nominal axial length of a corresponding printing form cylinder as used for printing onto super-format sheets, by an amount such that the at least one printing form cylinder (115, 125; 215; 315, 325) is suitable for printing onto large-format sheets having a comparatively greater width (W) than the width of super-format sheets. Preferably, a circumferential length (SL) of each segment of the at least one printing form cylinder (115, 125; 215; 315, 325) is comparatively greater than a nominal circumferential length of each segment of a corresponding printing form cylinder as used for printing onto super-format sheets, by an amount such that the at least one printing form cylinder (115, 125; 215; 315, 325) is suitable for printing onto large-format sheets having a comparatively greater length (L) than the length of super-format sheets.

### TECHNICAL FIELD

The present invention generally relates to a sheet-fed rotary printing press for the production of banknotes and like securities.

### BACKGROUND OF THE INVENTION

Banknotes and the like securities are commonly produced in the form of individual sheets each carrying a plurality of individual imprints arranged in a matrix of rows and columns, which sheets are subjected to various printing and processing steps before being cut into individual notes. Among the printing and processing steps typically carried out during the production of banknotes are offset printing, intaglio printing, silk-screen printing, foil application, letterpress printing and/or varnishing. Other processing steps might be carried out during the production such as window cutting, ink-jet marking, laser marking, micro-perforation, etc. Once fully printed, the sheets have to be subjected to a so-called finishing process wherein the sheets are processed, i.e. cut and assembled, to form note bundles and packs of note bundles.

Nowadays, most banknotes are produced on so-called super-sized (or “super format”) sheets, i.e. sheets having a standardized size of the order of 820 mm in width and 700 mm in length. Such super-sized sheets typically allow for an effective printed area of the order of 800 mm in width and 666 mm in length considering a typical unprinted margin of the order of 25 mm at the leading edge (also called “gripper edge”) of the sheet and left and right unprinted margins of typically 10 mm each. This effective printed area can potentially be increased in length by reducing the unprinted margin at the leading edge to e.g. 12.5 mm, thereby extending the length of the effective printed area to 678.5 mm.

Banknote dimensions may vary from one country to another and typically vary in width and/or in length within one and a same series depending on the relevant banknote denomination. Reference can be made in that respect to the paper entitled “Banknote dimensions and orientation: user requirements”, De Nederlandsche Bank NV, BPC/General Meeting, September 2006 (which paper is available online at www.dnb.nl).

In order to reduce waste to a minimum, banknote printers typically produce banknotes with dimensions that best fit within the allowable effective printed area of the sheet, it being to be understood once again that multiple banknote imprints are printed in a matrix arrangement of rows and columns within the effective printed area of the sheet.

There is a constant trend in the high-security printing industry towards improving productivity.

Nowadays, banknotes are typically produced at rates of approximately 10′000 sheets per hour (sph). Increasing production speed may allow for increased productivity, but one is inherently limited by physical and mechanical constraints which prevent in practice exceeding the aforementioned typical production rate of 10′000 sph. Furthermore, changing the production speed may have a negative effect on production quality and potentially create bottlenecks in the production where equipment is used that cannot match similarly high production rates.

Investments at all levels of the banknotes production, from the paper mills or like substrate manufacturers to the banknote printers, including equipment manufacturers, are substantial and it would not be reasonable to completely unsettle the existing practice by simply increasing sheet format again.

There is therefore a need for improved sheet-fed rotary printing presses that can achieve higher productivity at reasonable costs but with as little machine modifications as possible.

### SUMMARY OF THE INVENTION

A general aim of the invention is therefore to improve the sheet-fed rotary printing presses of the art.

A further aim of the invention is to provide such printing presses which allow for an increased productivity with limited adaptations on the machine side.

Another aim of the invention is to provide such printing presses which minimize the impact on the production of the necessary substrates to be processed by such printing presses.

These aims are achieved thanks to the sheet-fed rotary printing presses as defined in the claims.

Further advantageous embodiments of the invention form the subject-matter of the dependent claims and are discussed below.

### BRIEF DESCRIPTION OF THE DRAWINGS (IF ANY)

Other features and advantages of the present invention will appear more clearly from reading the following detailed description of embodiments of the invention which are presented solely by way of non-restrictive examples and illustrated by the attached drawings in which:

FIG. 1 is a schematic illustration of a sheet as used for the production of securities (such as banknotes), which sheet carries a plurality of imprints that are arranged in a matrix of (e.g. eight) rows and (e.g. five) columns;

FIG. 2 is a flow chart illustrating a known process for producing notes of securities (such as banknotes) wherein a small part of the production is subjected to single-note processing;

FIG. 3A is a schematic illustration of a paper web (or like substrate web) as conventionally produced by paper manufacturers, which paper web is typically subdivided into three individual webs for the production of super-format sheets;

FIG. 3B is a schematic illustration of a paper web exhibiting the same web width as that of FIG. 3A, which paper web is however subdivided into two individual webs for the production of large-format sheets;

FIG. 4A is a schematic side view of a cylinder, perpendicular to the axis of the cylinder, which is illustrative of cylinder dimensions of relevant cylinders of the sheet-fed rotary printing presses of the invention;

FIG. 4B is a schematic side view of the cylinder of FIG. 4A, parallel to the axis of the cylinder, which is further illustrative of the cylinder dimensions of the relevant cylinder of the sheet-fed rotary printing presses of the invention;

FIG. 5 is a schematic side view of a simultaneous recto-verso (“Simultan”) offset printing press for the production of banknotes and like securities;

FIG. 6 is a schematic partial side view of the printing group of the offset printing press of FIG. 5;

FIG. 7 is a schematic partial side view of the printing group of the offset printing press of FIG. 5 with mobile inking carriages in retracted positions;

FIG. 8 is a schematic side view of a five-colour indirect (“Orlof”) intaglio printing press for the production of banknotes and like securities;

FIG. 9 is a schematic partial side view of the printing group of the intaglio printing press of FIG. 8;

FIG. 10 is a schematic side view of a letterpress printing press for the production of banknotes and like securities, namely for the purpose of carrying out a numbering operation; and

FIG. 11 is a schematic partial side view of the printing group of the letterpress printing press of FIG. 10.

### DETAILED DESCRIPTION OF EMBODIMENTS OF THE INVENTION

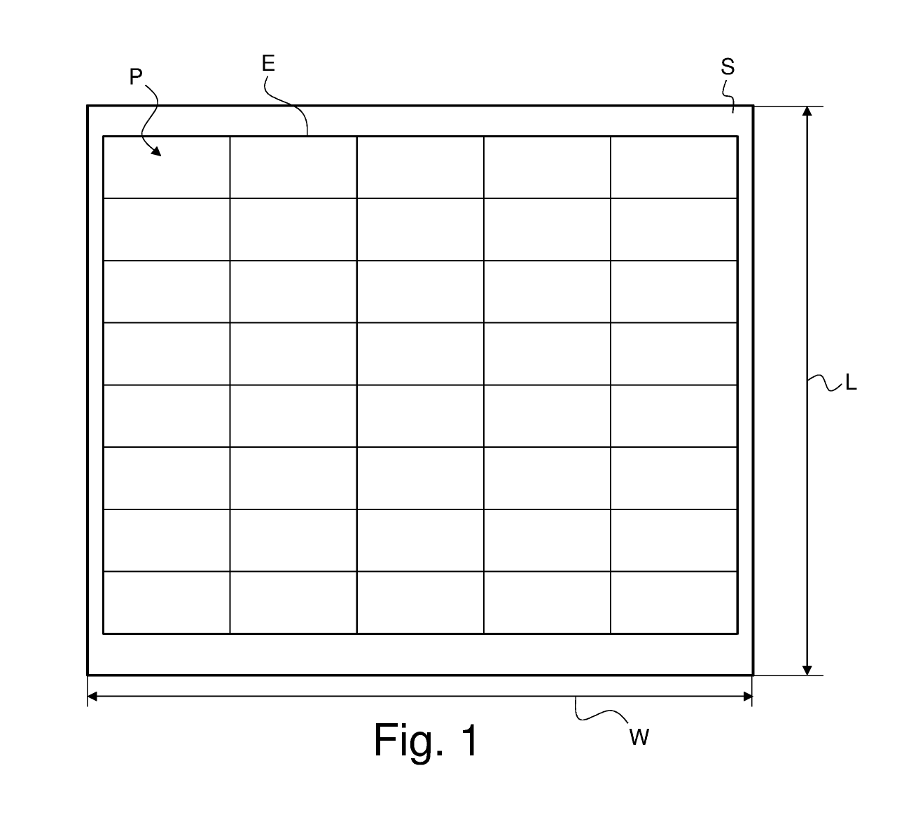

The present invention will be described in the particular context of the production of banknotes. As already mentioned, banknotes are typically produced in the form of sheets each carrying a plurality of imprints which are arranged in a matrix of rows and columns. FIG. 1 schematically illustrates a sheet S as used for the production of banknotes, which sheet S bears an effective printed area E consisting of multiple (banknote) imprints P which are arranged in a regular pattern of rows and columns. The sheet S exhibits margin portions next to the effective printed area E, which margin portions are typically exploited for the purpose of printing control patterns or the like.

The expressions “super-format sheet(s)” and “super-sized sheet(s)”, which are both used herein to designate one and a same sheet format, shall be understood as referring to sheets as used in particular for the production of banknotes, which sheets exhibit a standardized format of the order of 820 mm×700 mm, i.e. a sheet width W (transversely to the direction of printing) of the order of 820 mm and a sheet length L (parallel to the direction of printing) of the order of 700 mm. In contrast, the expression “large-format sheet(s)” as also used herein shall be understood as referring to any sheet format exhibiting a noticeably larger format compared to the super-format sheet(s), namely sheets exhibiting a sheet width W greater than 820 mm and, preferably, a sheet length L greater than 700 mm.

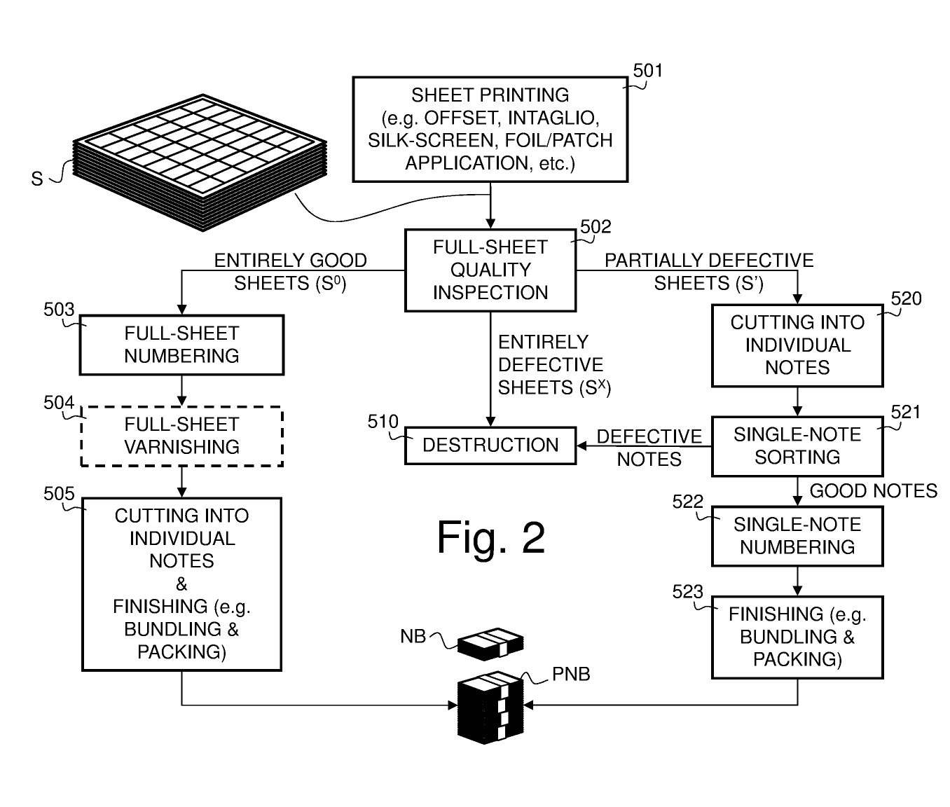

FIG. 2 summarizes a typical process of producing banknotes (or like securities) wherein a final inspection step is carried out prior to finishing. The production process illustrated in FIG. 2 is advantageous in that it enables maximisation of the production efficiency by reducing waste to a minimum and enables the production of note bundles and packs of note bundles with uninterrupted numbering sequence. This process is basically applicable irrespective of the particular sheet format.

Step 501 in FIG. 2 denotes the various printing phases which are typically carried out during the production of banknotes. As mentioned, these various printing phases typically include an offset printing phase whereby banknote sheets are printed on one or both sides with an offset background, an intaglio printing phase whereby the sheets are printed on one or both sides with intaglio features (i.e. embossed/relief features which are readily recognizable by touch), a silk-screen printing phase whereby the sheets are printed on one or both sides with silk-screen features, such as features made of optically variable ink (OVI), and/or a foil/patch application phase whereby foils or patches, in particular so-called optically variable devices (OVD), holograms, or similar optically diffractive structures, are applied onto one or both sides of the sheets, etc.

As a result of the various printing phases of step 501, successive sheets S are produced. While quality control checks are usually performed at various stages during the production of the securities, a final quality check is typically carried out on the full sheets S after these have completely been printed. This full-sheet quality inspection is schematised by step 502 in FIG. 2. Three categories of sheets in terms of quality requirements are generated as a result of this full-sheet quality inspection, namely (i) entirely good sheets S⁰ (i.e. sheets carrying imprints which are all regarded to be satisfactory from the point of view of the quality requirements), (ii) partially defective sheets S′ (i.e. sheets carrying a mixtures of imprints which are satisfactory from the point of view of the quality requirements and imprints which are unacceptable, which defective imprints are typically provided with a distinct cancellation mark), and (iii) entirely defective sheets S^{X} carrying only defective imprints. From this point onward, the three categories of sheets follow distinct routes. More precisely, the entirely defective sheets S^{X} are destroyed at step 510, while the entirely good sheets S° are processed at steps 503 to 505 and the partially defective sheets S′ are processed at steps 520 to 523.

Referring to steps 503 to 505, the entirely good sheets S° are typically numbered at step 503, then optionally varnished at step 504, and finally cut and subjected to an ultimate finishing process at step 505, i.e. stacks of sheets S are cut into individual bundles of securities (such as banknote bundles) NB, which bundles NB are typically banderoled (i.e. surrounded with a securing band) and then stacked to form packs of bundles PNB. While the sheets S are processed in succession at steps 503 and 504, step 505 is usually carried out on stacks of hundred sheets each, thereby producing successive note bundles NB of hundred securities each, which note bundles NB are stacked to form e.g. packs PNB of ten note bundles each.

Referring to steps 520 to 523, the partially defective sheets S′ are firstly cut into individual notes at step 520 and the resulting securities are then sorted out at step 521 (based on the presence or absence of the cancellation mark previously applied on the defective imprints at step 502), the defective notes being destroyed at step 510, while the good notes are further processed at steps 522 and 523. At step 522, the individual securities are numbered in succession and subsequently subjected to a finishing process at step 523 which is similar to that carried out at step 505, i.e. note bundles of securities NB are formed, which note bundles NB are banderoled and then stacked to form packs of note bundles PNB.

As regards the varnishing operation, FIG. 2 shows that such varnishing is typically carried out on full sheets at step 504 after full-sheet numbering at step 503. While this varnishing step is preferred, it is not as such required. Varnishing may furthermore be carried out at a different stage of the production, for example before full-sheet inspection at step 502 or immediately after full-sheet inspection at step 502, on the entirely good sheets S° and partially defective sheets S′ (which other solution would imply that numbering is carried out after varnishing).

In case keeping the numbering sequence throughout the notes of successive bundles 200 is not required, the partially defective sheets S′ could follow a somewhat similar route as the entirely good sheets S°, i.e. be subjected to a full-sheet numbering step (thereby numbering both the good and defective imprints), then to full-sheet varnishing, before being cut into individual securities, sorted out to extract and destroy the defective securities, and then subjected to an ultimate finishing process to form note bundles and packs of note bundles (in this case single-note numbering would not be required).

In any event, FIG. 2 only illustrates a possible banknote production process and variations thereof are possible.

Super-format sheets are typically produced on special paper machines in the form of a paper web having a determined web width (also referred to as wire width). Security paper is typically made from cotton material which is transformed into a web and processed to incorporate or be otherwise provided with a variety of security features, including watermarks, security threads, synthetic fibres, planchettes, foils, and possibly printed features or coatings. Examples include the LongLife™ durable paper as manufactured by Papierfabrik Louisenthal or like paper substrates manufactured by other paper manufacturers, such as De La Rue, ArjoWiggins, and LandQart. Alternatives to cotton-based security paper are polymer substrates or so-called hybrid substrates, which combine paper layers with polymer layers. Examples include the Guardian™ substrate supplied by Innovia Security which is made from a polymer substrate, namely bi-axially oriented polypropylene (BOPP), that is provided on both sides with white opacifying layers, or the Hybrid™ substrate manufactured by Papierfabrik Louisenthal, which combines a core paper layer with thin polyester films on both sides.

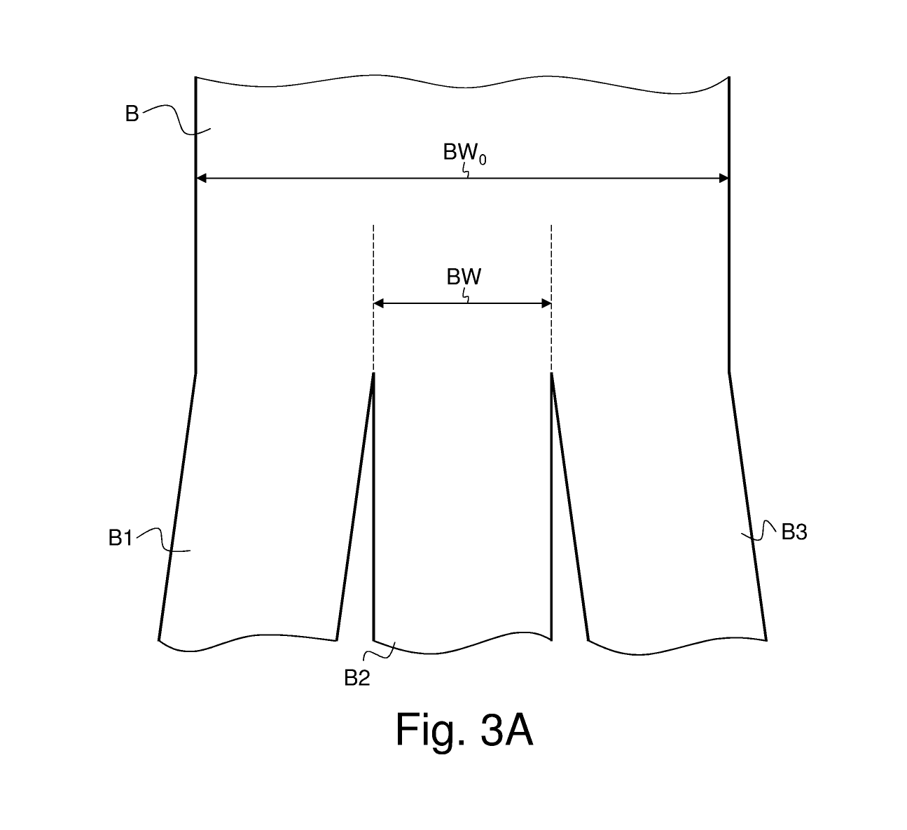

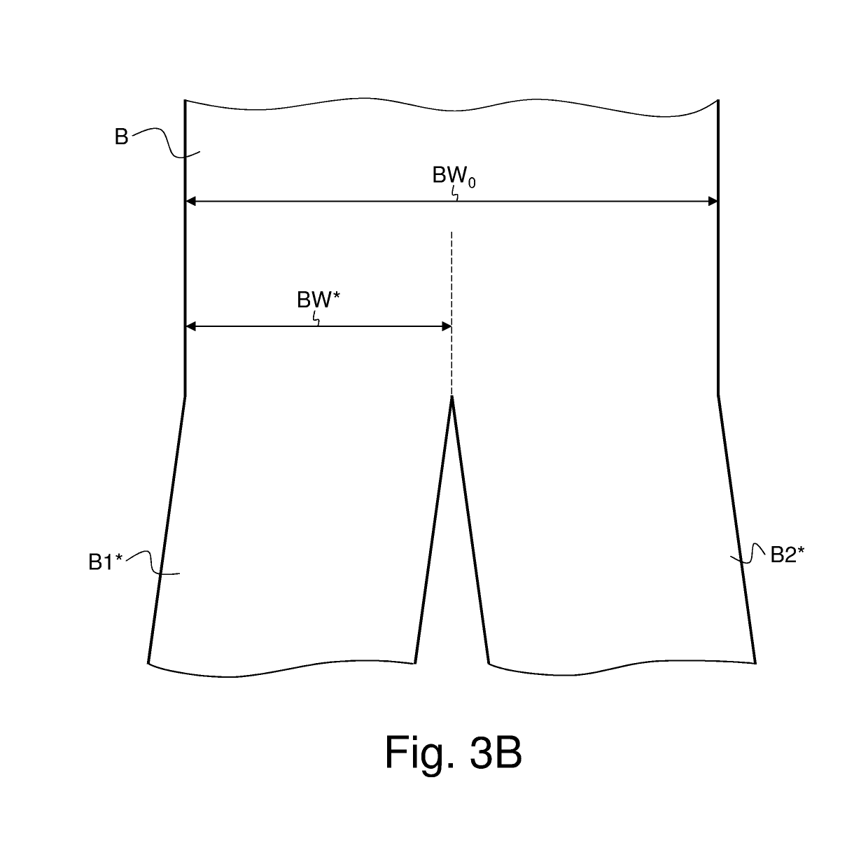

As schematically illustrated in FIG. 3A, a paper web is conventionally produced in the form of a substrate web B exhibiting a width BW₀ which is greater than the required dimensions of the sheets and then subdivided into individual webs B1, B2, B3, . . . , of a reduced width BW before being ultimately cut into individual sheets. As an illustration, the width BW₀ of the paper web is typically of the order of 2500 to 2800 mm and is subdivided into three individual webs B1, B2, B3 of a width BW corresponding substantially to the width W of the super-format sheets S, i.e. 820 mm, it being to be understood that waste is to be accounted for.

In the context of the present invention, higher productivity is achieved thanks to an increase of the sheet format. Preferably, the sheet format, in particular the sheet width W, is increased by taking into account the aforementioned requirements of paper manufacturers. Namely, a width W of the large-format sheets is advantageously selected to correspond substantially to an integer fraction of the width BW₀ of the substrate web B as produced by paper mills or the like substrate manufacturers.

Referring to the aforementioned typical example where the substrate web B exhibits a width BW₀ of the order of 2500 to 2800 mm, which substrate web B is normally subdivided into three individual webs B1, B2, B3 for the production of super-format sheets, it is highly advantageous to contemplate to subdivide the substrate web B into two halves B1*, B2* exhibiting a larger width BW*, as schematically illustrated by FIG. 3B. In this way, the increase of the sheet width W of the large-format sheets does not substantially impact the existing equipment used for paper manufacture and only requires reasonably simple adaptations of the paper production line.

Referring to the above example where the web width BW₀ is of the order of 2500 to 2800 mm, one shall therefore understand that it is easily possible to produce two individual webs B1*, B2* exhibiting a width BW* in the range of 1200 to 1300 mm. Within the context of the present invention, one shall preferably consider a width BW* that can suitably allow for the production of large-format sheets exhibiting a width W of the order of 1240 to 1250 mm. When making this choice, one obviously needs to take into consideration that waste should be reduced to a reasonable minimum. In the following, it will be assumed that the sheet width W of the large-format sheets is selected to be of the order of 1240 mm, i.e. an increase of approximately 50% in width compared to the super-format sheets.

The increase in sheet width W of the large-format sheets impacts the required dimensions (namely the axial length) of the cylinders of the printing presses that shall process such large-format sheets.

In the context of the present invention, rather than increasing all cylinder dimensions (which would be a straightforward choice but would have a considerable impact on all printing press configurations), one contemplates to increase the cylinders' axial length to cope with the increased sheet width W, while sticking at the same time with the same cylinder diameters as used for processing conventional super-format sheets.

This has the considerable advantage that the printing press configurations can basically remain the same as far as cylinder diameters and cylinder arrangements are concerned, but need to be adapted in one dimension, namely along the axis of the cylinders.

This further means that side frames of the printing press can basically remain the same between a large-format printing press in accordance with the present invention and the corresponding super-format printing press exhibiting a similar cylinder arrangement.

This being said, the increase in sheet format will also necessitate some adaptations in the circumferential direction in order to cope with the increased sheet length L. In that respect, what is determinant is the actual sheet length L of the large-format sheets and the maximum allowable length, in the circumferential direction, of each segment of the relevant cylinder.

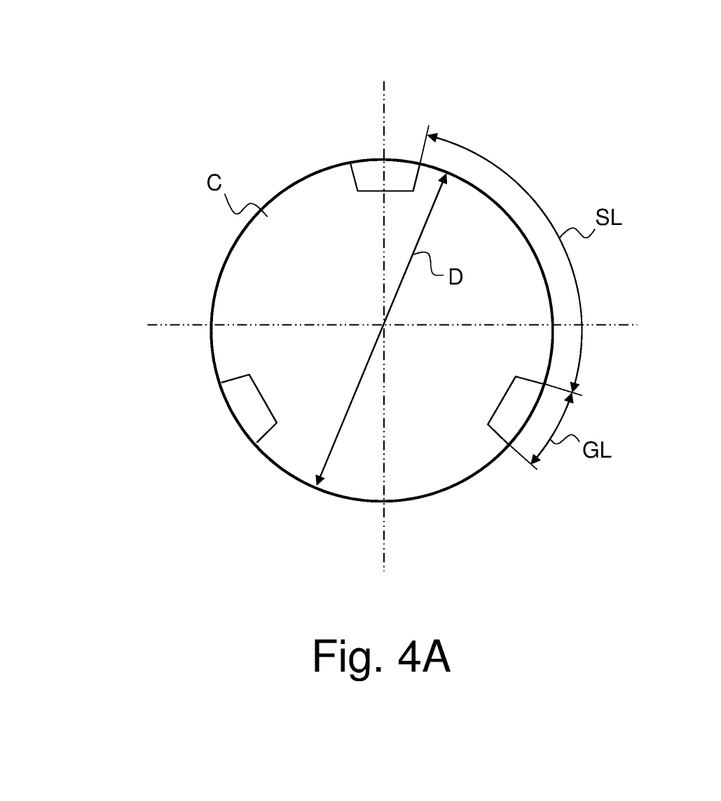

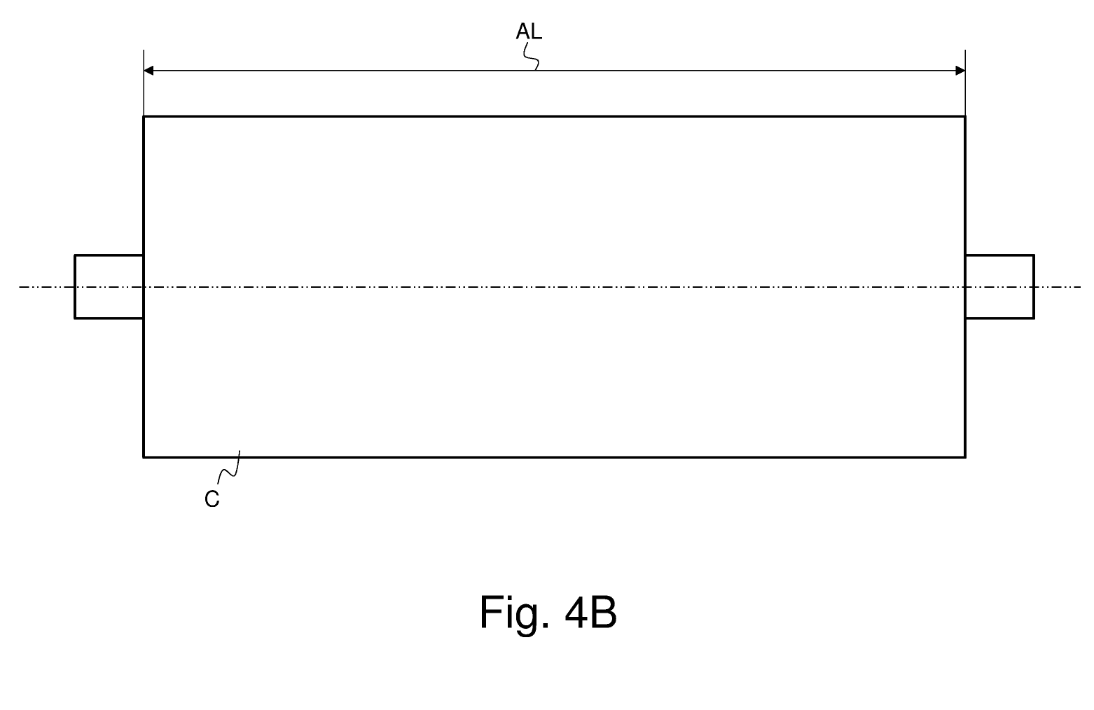

Cylinder C in FIGS. 4A and 4B is basically illustrative of any cylinder of a printing group of the relevant printing press, whose dimensions (namely cylinder diameter D, cylinder segment length SL and cylinder axial length AL) are related to the format of the sheets to be processed, irrespective of the number of segments of the cylinder. This in particular includes:
printing form cylinders (such as plate cylinders) which carry one or more printing forms (i.e. having one or more segments);
inking cylinders (such as chablon cylinders) which carry one or more inking chablons;
blanket and impression cylinders which carry one or more ink transfer or impression blanket; and
sheet transfer cylinders (or drums) which cooperate with any of the above.

While FIG. 4A shows a three-segment cylinder, it shall be appreciated that the relevant considerations regarding cylinder dimensions are applicable independently of the number of cylinder segments of the relevant cylinder.

For the sake of illustration, one shall specifically refer to the dimensions of the relevant printing form cylinder(s) of the printing press as comparative reference with the printing form cylinder(s) of the corresponding super-format printing presses, it being understood that the relevant printing form cylinder(s) can have one or more segments.

As far as the axial length AL of the relevant printing form cylinder(s) is concerned, this axial length AL shall be greater than a nominal axial length of a corresponding printing form cylinder as used for printing onto super-format sheets, by an amount such that the relevant printing form cylinder(s) is/are suitable for printing onto the large-format sheets which have a comparatively greater width (e.g. 1240 mm) than the width (i.e. 820 mm) of super-sized sheets. In the present example, the axial length AL would therefore exceed the width W of the large format sheets, i.e. be greater than 1240 mm.

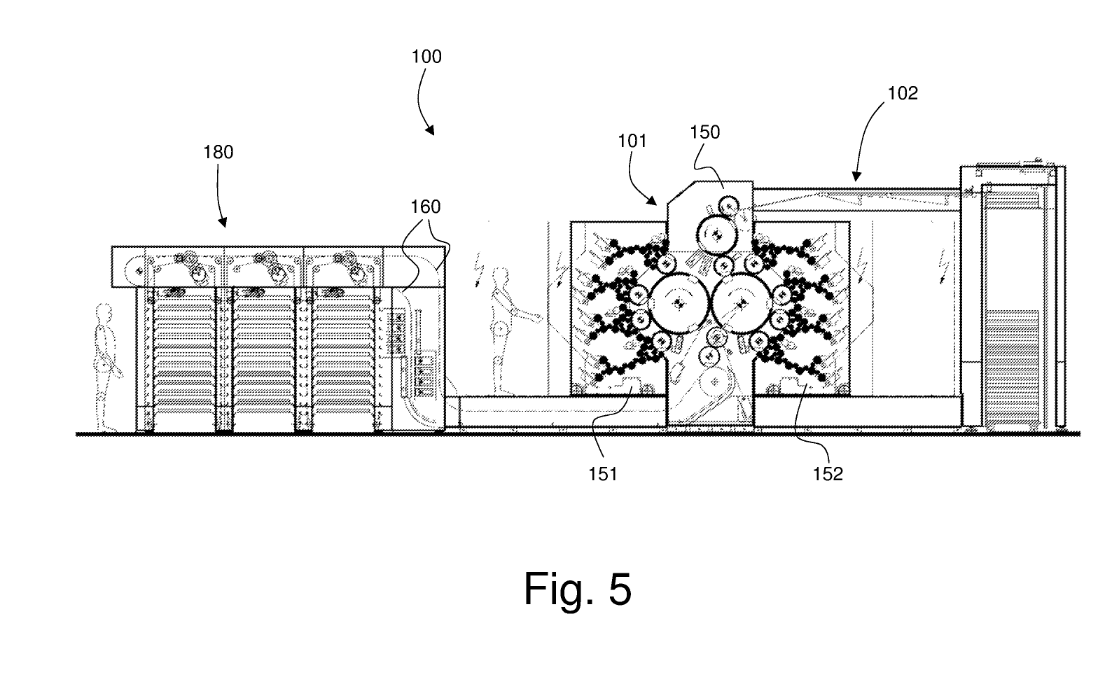

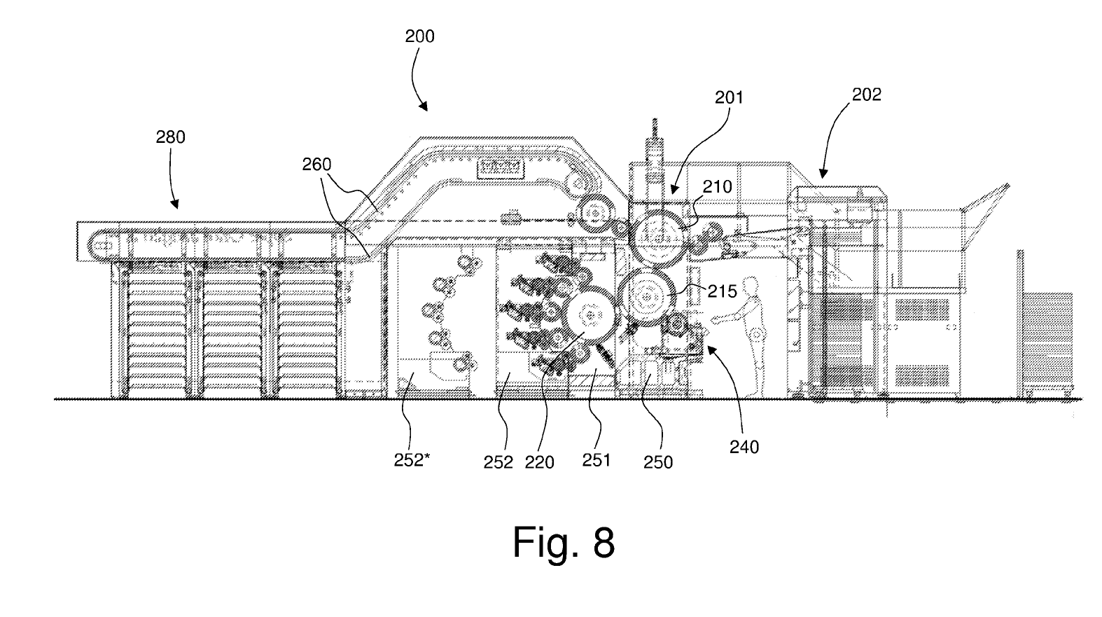

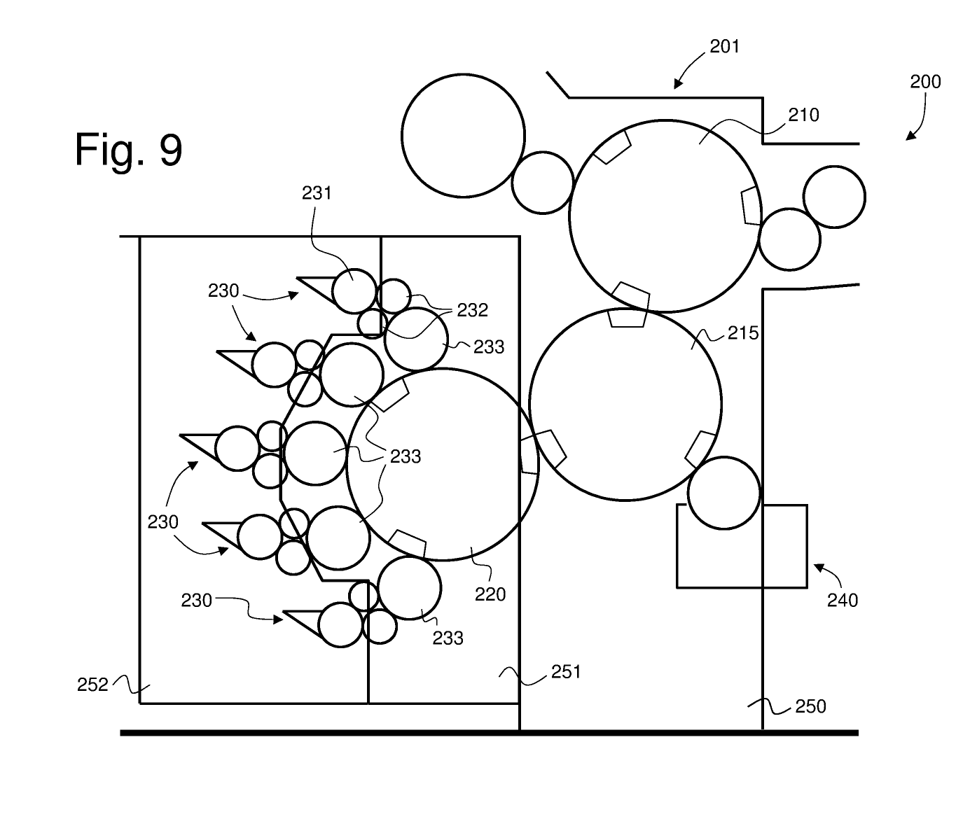

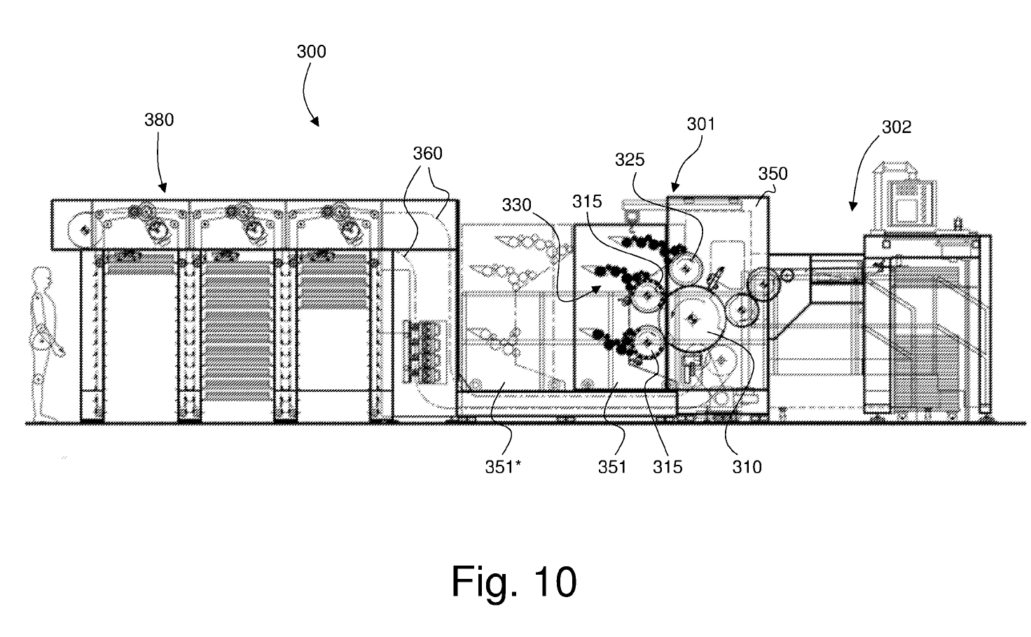

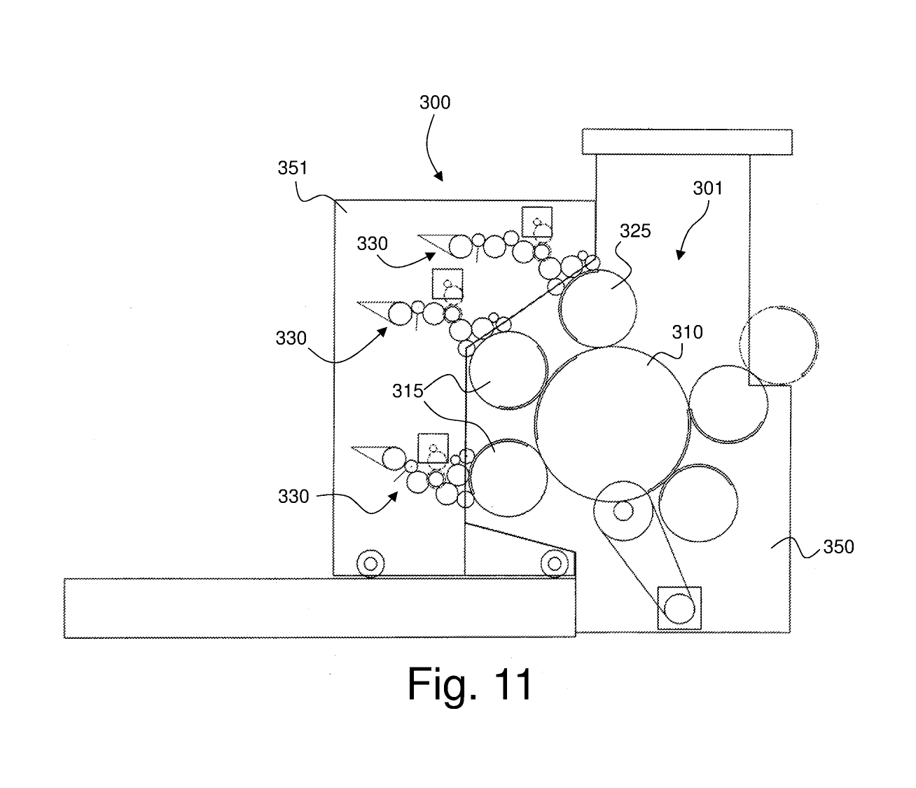

As regards the cylinder diameter, a nominal diameter D of the relevant printing form cylinder(s) shall substantially correspond to an integer multiple of the reference diameter of a one-segment cylinder as used for printing onto super-format sheets. The reference diameter of a super-sized one-segment cylinder is typically, depending on the type of printing press, of 280 mm or 374 mm. Considering a nominal diameter of 280 mm as reference, a one-segment plate cylinder of e.g. an offset printing press (see e.g. FIGS. 5 to 7, reference numerals 115 and 125) would exhibit a nominal diameter of the order of 280 mm, while a three-segment plate cylinder of e.g. an intaglio printing press (see e.g. FIGS. 8 and 9, reference numeral 215) would exhibit a nominal diameter of the order of 840 mm. Similarly, considering a nominal diameter of 374 mm as reference, a one-segment letterpress cylinder of e.g. a numbering press (see e.g. FIGS. 10 and 11, reference numerals 315 and 325) would exhibit a nominal diameter of 374 mm.

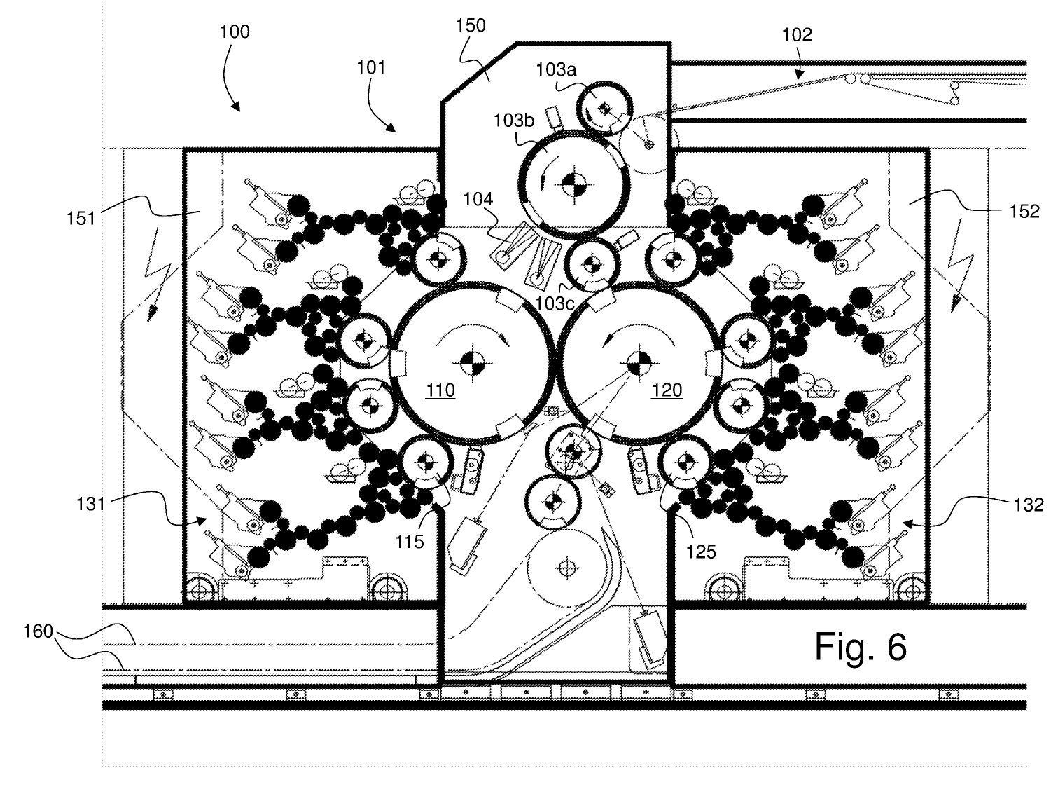

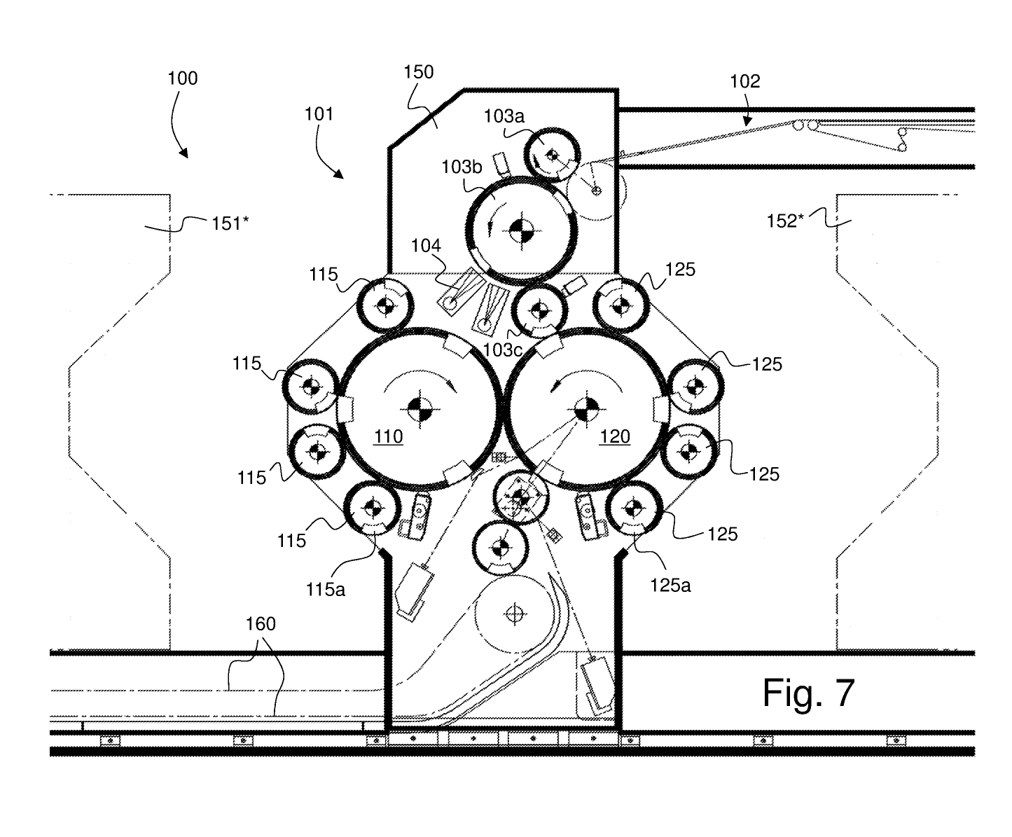

The diameter of blanket or impression cylinder(s) (such as the three-segment blanket cylinders 110, 120 of FIGS. 5 to 7, the three-segment impression cylinder 210 of FIGS. 8, 9 of the two-segment impression cylinder 310 of FIG. 10, 11) would basically follow the same rule, as briefly discussed hereinafter. Other cylinders, like the chablon cylinders 233 of FIG. 9 or the transfer cylinders 103a, 103b, 103c of FIGS. 6 and 7, would likewise obey the same rule.

It is to be appreciated that the nominal diameter of the relevant cylinders may slightly deviate from an exact integer multiple of the aforementioned reference diameter (n×280 mm or n×374 mm, where n=1, 2, 3, 4, . . . ), since these cylinders are typically designed to carry printing forms, blankets, and/or additional packing sheets or underlays. Within the scope of the present invention, the effective diameter of the relevant cylinder may therefore deviate by a few tenths of a millimetre from an exact integer multiple of the aforementioned reference diameter.

Referring to FIG. 4A, the cylinder segment length SL would need to be accommodated to cope, as the case may be, with the relevant sheet length L of the large-format sheet. More precisely, assuming a sheet length L of more than 700 mm, the circumferential length SL of each segment of the relevant printing form cylinder(s) should in this case be greater than a nominal circumferential length of each segment of a corresponding printing form cylinder as used for printing onto super-format sheets, by an amount such that the relevant printing form cylinder(s) is/are suitable for printing onto large-format sheets which have a comparatively greater length L than the length (i.e. 700 mm) of super-sized sheets. While FIG. 4A shows a three-segment cylinder C, it should be appreciated that the relevant cylinder could comprise any number of segments, namely one or more segments. In that respect, the expression “each segment” used herein also encompasses examples where the relevant cylinders include only one segment.

It will readily be appreciated that the circumference of the relevant cylinder, which is related to the cylinder diameter D, is directly related to the number of cylinder segments (i.e. n=1, 2, 3, . . . ) and the sum of the circumferential length SL of each segment and of the cylinder gap length GL (where corresponding clamping systems are typically mounted) as follows:

π×D=n×(SL+GL) (1)

For practical reasons, the cylinder gap length GL cannot be reduced to zero. This being said, one can still play with the cylinder gap length GL, namely reduce it, to achieve a reasonable increase in the cylinder segment length SL so as to cope with large-format sheets exhibiting a length L greater than 700 mm. The practical limit is defined by the smallest possible cylinder diameter (i.e. 280 mm) and the minimum practical gap length GL.

A one-segment cylinder (e.g. plate cylinder) for printing onto super-format sheets typically exhibits a cylinder segment length SL of the order of magnitude of the sheet length L of the super-format sheet, i.e. approximately 700 mm, which leaves a cylinder gap length GL of about 180 mm. One can easily achieve an increase of the cylinder segment length SL of at least 20 mm by reducing the cylinder gap length GL by the same amount, which would allow for an increase of the sheet length L of the large-format sheet to 720 mm. In view of the space available, one may even achieve an increase of the sheet length L of the large-format sheet up to 800 mm (or possibly slightly more). In view of practical constraints (namely the minimum practical gap length), one may define the upper limit as being of the order of 800 mm. Beyond that limit, the cylinder gap length GL may become too small.

In the context of the present invention, on shall therefore understand that the large-format sheets would preferably exhibit a sheet length L of the order of 720 mm to 800 mm.

Large-format sheets of (W=)1240 mm×(L=)720 mm would allow higher productivity in excess of 50% compared to super-format sheets, while such higher productivity would climb up to more than 70% with large-format sheets of (W=)1240 mm×(L=)800 mm. Thanks to the present invention, this substantially higher productivity can be achieved without this necessitating substantial revisions of the printing press configurations beyond the aforementioned increase in axial length AL of the cylinders and, preferably, increase in cylinder segment length SL.

Reference to FIGS. 5 to 11 will help emphasising the advantages resulting from the present invention.

FIGS. 5 to 7 illustrate a simultaneous recto-verso offset printing press (or “Simultan offset printing press”), designated globally by reference numeral 100, for the production of banknotes and like securities. The basic configuration of this printing press is already described in International application No. WO 2007/105059 A1 (and corresponding US publication No. US 2009/0025594 A1), which publication is incorporated herein by reference in its entirety. Further information about such printing presses is also disclosed in European patent No. EP 0 949 069 B1 (and corresponding U.S. Pat. No. 6,101,939) and International applications Nos. WO 2007/042919 A2 (and corresponding US publication No. US 2008/0271620 A1) and WO 2007/105061 A1 (and corresponding US publication No. US 2009/0007807 A1). All of the above-listed applications are incorporated herein by reference in their entirety.

The printing group of the press 101, which is adapted in this case to perform simultaneous recto-verso offset printing of the sheets, comprises in a conventional manner two blanket cylinders (or impression cylinders) 110, 120 (referenced in FIGS. 6 and 7) rotating in the direction indicated by the arrows and between which the sheets are fed to receive multicolour impressions. In this example, blanket cylinders 110, 120 are three-segment cylinders which are supported between a pair of side frames designated by reference numeral 150. The blanket cylinders 110, 120 receive and collect different ink patterns in their respective colours from plate cylinders 115 and 125 (four on each side) which are distributed around a portion of the circumference of the blanket cylinders 110, 120. These plate cylinders 115 and 125, which each carry a corresponding printing plate, are themselves inked by corresponding inking units 131 and 132, respectively, in a manner known in the art. The two groups of inking units 131 and 132 are advantageously placed in two inking carriages 151, 152 that can be moved toward or away from the centrally-located plate cylinders 115, 125 and blanket cylinders 110, 120. FIG. 7 in particular shows the printing press with the movable inking carriages, designated by reference numerals 151*, 152* for the sake of distinction, moved to retracted positions during maintenance operations, including for the purpose of changing and mounting printing plates on the plate cylinders 115, 125.

As is known in the art, each printing plate is wrapped around the corresponding plate cylinder 115, 125 and clamped at its leading end and trailing end by a suitable plate clamping system, which plate clamping system is located in a corresponding cylinder pit of the plate cylinder. Such cylinder pits are designated by reference numerals 115a and 125a in FIG. 7.

Sheets are fed from a sheet feeding group 102 (including a feeder and feeder table) located next to the printing group 101 (on the right-hand side in FIGS. 5 to 7) to a succession of transfer cylinders 103a, 103b, 103c (three cylinders in this example) placed upstream of the blanket cylinders 110, 120. While being transported by the transfer cylinder 103b, the sheets may optionally receive a first impression on one side of the sheets using an additional printing group (not illustrated) as described in European patent No. EP 0 949 069 B1 and International application No. WO 2007/042919 A2, transfer cylinder 103b fulfilling the additional function of impression cylinder in such a case. In case the sheets are printed by means of the optional additional printing group, these are first dried by a drying or curing unit 104 before being transferred to the blanket cylinders 110, 120 for simultaneous recto-verso printing.

In the example of FIGS. 5 to 7, the sheets are transferred onto the surface of blanket cylinder 120 where a leading edge of each sheet is held by appropriate gripper means located in cylinder pits between each segment of the blanket cylinder 120. Each sheet is thus transported by the blanket cylinder 120 to the printing nip between the blanket cylinders 110 and 120 where simultaneous recto-verso printing occurs. Once printed on both sides, the printed sheets are then transferred as known in the art to a chain gripper system 160 for delivery in a sheet delivery station 180 comprising multiple delivery pile units (three in this example).

In the example of FIGS. 5 to 7, first and second transfer cylinders (not referenced), such as suction drums or cylinders, are interposed between the chain gripper system 160 and the blanket cylinder 120. These first and second transfer cylinders are designed to carry out inspection of the sheets on the recto and verso sides as described in International application No. WO 2007/105059 A1. Whether or not these first and second transfer cylinders are provided does not impact on the subject-matter of the instant invention and such cylinders may accordingly be omitted.

It will be appreciated that the processing of large-format sheets on the printing press 100 of FIGS. 5 to 7 would merely require adaptation of the axial length AL of the cylinders of the printing press 100 and, as the case may be, adaptations of the cylinder segment length SL of part of the cylinders, in particular of the plate cylinders 115, 125, the blanket cylinders 110, 120, and the transfer cylinders 103a, 103b, 103c.

Thanks to the invention, the adaptations do not however affect the overall cylinder arrangement of the printing group 101 as the cylinder diameters remain unchanged compared to a standard super-sized offset printing press. In other words, the same side frames 150, as well as the same side frames of the mobile carriages 151, 152 can be exploited.

FIGS. 8 and 9 schematically illustrate a five-colour Orlof intaglio printing press, which printing press is generally designated by reference numeral 200.

More precisely, FIG. 8 shows a sheet-fed intaglio printing press 200 comprising a sheet feeder group 202 (including sheet feeder and feeder table) for feeding sheets to be printed, a printing group 201 where intaglio printing of the sheets is carried out, and a sheet delivery station 280 for collecting the freshly-printed sheets. The printing group 201 includes an impression cylinder 210, a plate cylinder 215 (in this example, the plate cylinder 215 is a three-segment plate cylinder carrying three intaglio printing plates), an inking system comprising an ink-collecting cylinder, or Orlof cylinder, 220 (here a three-segment blanket cylinder carrying a corresponding number of blankets) for inking the surface of the intaglio printing plates carried by the plate cylinder 215 and an ink wiping system 240 for wiping the inked surface of the intaglio printing plates carried by the plate cylinder 215 prior to printing of the sheets.

The sheets are fed from the sheet feeder group 202 onto the impression cylinder 210. The sheets are then carried by the impression cylinder 210 to the printing nip between the impression cylinder 210 and the plate cylinder 215 where intaglio printing is performed. Once printed, the sheets are transferred away from the impression cylinder 210 for conveyance by a sheet transporting system 260 in order to be delivered to the delivery station 280. The sheet transporting system 260 conventionally comprises a sheet conveyor system with a pair of endless chains driving a plurality of spaced-apart gripper bars for holding a leading edge of the sheets (the freshly-printed side of the sheets being oriented downwards on their way to the sheet delivery station 280), sheets being transferred in succession to a corresponding one of the gripper bars.

During their transport to the sheet delivery station 280, the freshly printed sheets are preferably inspected by an optical inspection system (not referenced). In the illustrated example, the optical inspection system is advantageously an inspection system as disclosed in International Publication No. WO 2011/161656 A1 (which publication is incorporated herein by reference in its entirety), which inspection system comprises a transfer mechanism and an inspection drum located at the transfer section between the impression cylinder 210 and chain wheels of the sheet transporting system 260. The optical inspection system could alternatively be an inspection system placed along the path of the sheet transporting system 260 as described in International Publications Nos. WO 97/36813 A1, WO 97/37329 A1, and WO 03/070465 A1. Such inspection systems are in particular marketed by the Applicant under the product designation NotaSave®.

FIG. 9 is a schematic view of the intaglio printing group 201 of the intaglio printing press 200 of FIG. 8. As already mentioned, the printing group 201 basically includes the impression cylinder 210, the plate cylinder 215 with its (three) intaglio printing plates, the inking system with its ink-collecting cylinder 220, and the ink wiping system 240.

The inking system comprises in this example five inking devices 230, all of which cooperate with the ink-collecting cylinder 220 that contacts the plate cylinder 215. It will be understood that the illustrated inking system is adapted for indirect inking of the plate cylinder 215, i.e. inking of the intaglio printing plates via the ink-collecting cylinder 220. The inking devices 230 each include an ink duct 231 cooperating in this example with a pair of ink-application rollers 232. Each pair of ink-application rollers 232 in turn inks a corresponding chablon cylinder 233 which is in contact with the ink-collecting cylinder 220. As is usual in the art, the surface of the chablon cylinders 233 is structured so as to exhibit raised portions corresponding to the areas of the intaglio printing plates intended to receive the inks in the corresponding colours supplied by the respective inking devices 230.

As shown in FIGS. 8 and 9, the impression cylinder 210 and plate cylinder 215 are both supported in a (stationary) frame, between a pair of side frames, designated by reference numeral 250. The inking devices 230 (including the ink duct 231 and ink-application rollers 232) are supported in a mobile inking carriage 252, while the ink-collecting cylinder 220 and chablon cylinders 233 are supported in an intermediate carriage 251 located between the inking carriage 252 and the stationary frame. Both the inking carriage 252 and the intermediate carriage 251 are advantageously suspended under supporting rails. In FIG. 8, reference numeral 252* designates the inking carriage 252 in a retracted position.

The twin-carriage configuration of the intaglio printing press 200 illustrated in FIGS. 8 and 9 corresponds in essence to the configuration disclosed in International Publications Nos. WO 03/047862 A1, WO 2011/077348 A1, WO 2011/077350 A1 and WO 2011/077351 A1, all assigned to the present Applicant and which are incorporated herein by reference in their entirety.

It shall be understood that the ink-collecting cylinder 220 could be omitted and the various inking devices 230 designed to transfer ink directly to the plate cylinder 215. Inking systems combining a direct and indirect inking of the plate cylinder 215 could also be contemplated.

It will be again be appreciated that the processing of large-format sheets on the printing press 200 of FIGS. 8 and 9 would merely require adaptation of the axial length AL of the cylinders of the printing press 200 and, as the case may be, adaptations of the cylinder segment length SL of part of the cylinders, in particular of the plate cylinder 215, the impression cylinder 210, the ink-collecting cylinder 220, and the chablon cylinders 233.

Thanks to the invention, the adaptations do not however affect the overall cylinder arrangement of the printing group 201 as the cylinder diameters remain once again unchanged compared to a standard super-sized intaglio printing press. In other words, the same side frames 250, as well as the same side frames of the mobile carriages 251, 252 can be exploited.

In the context of the embodiments of FIGS. 5 to 9, it shall be appreciated that the relevant reference diameter of a corresponding super-sized one-segment cylinder is of 280 mm, meaning in particular that the one-segment plate cylinders 115, 125 of FIGS. 5 to 7 have a nominal diameter D of 280 mm, while the three-segment plate cylinder 215 of FIGS. 8 and 9 has a nominal diameter D of 840 mm.

FIGS. 10 and 11 illustrate yet another printing press that can be adapted for processing large-format sheets in accordance with the present invention. This printing press, which is generally designated by reference numeral 300, is a letterpress printing press which is in particular used for numbering banknotes. The printing press 300 generally comprises a sheet feeder group 302 feeding successive sheets to a printing group 301, which sheets are transported in succession, after the printing operation, to a sheet delivery station 380, by means of a sheet transporting system 360 similar to the sheet transporting systems 160 and 260 of FIGS. 5 to 9.

In this example, the sheets are fed via two one-segment transfer cylinders (not referenced) to a two-segment impression cylinder 310. This impression cylinder 310 is supported, together with three letterpress printing form cylinders 315, 325, between a pair of side frames 350. The two letterpress printing form cylinders 315 are designed as numbering cylinders (which carry a plurality of numbering boxes), while the third (optional) letterpress printing form cylinder 325 may carry a letterpress printing plate. Inking devices 330 are supported in a mobile inking carriage 351 so as to be retractable away from the printing group 301 during maintenance. Reference numeral 351* in FIG. 10 designates the mobile inking carriage 351 in a retracted position

It will be again be appreciated that the processing of large-format sheets on the printing press 300 of FIGS. 10 and 11 would merely require adaptation of the axial length AL of the cylinders of the printing press 300 and, as the case may be, adaptations of the cylinder segment length SL of part of the cylinders, in particular of the numbering cylinders 315 (in this case, the relevant arrangement of the numbering boxes on the numbering cylinders needs to be adjusted), the letterpress plate cylinder 325 and the impression cylinder 310.

The adaptations do not however affect the overall cylinder arrangement of the printing group 301 as the cylinder diameters remain once again unchanged compared to a standard super-sized numbering press. In other words, the same side frames 350, as well as the same side frames of the mobile carriage 351 can be exploited.

In the context of the embodiment of FIGS. 10 and 11, it shall be appreciated that the relevant reference diameter of a corresponding super-sized one-segment cylinder is of 374 mm, meaning in particular that the one-segment letterpress cylinders 315, 325 have a nominal diameter D of 374 mm, while the two-segment impression cylinder 310 has a nominal diameter D of 748 mm.

It will therefore be appreciated that a substantially higher productivity can be achieved thanks to the invention by an appropriate selection of a suitable larger sheet format, while at the same time limiting the impact of the change to the larger sheet format on the necessary adaptations of the printing presses. Furthermore, the larger sheet format can be suitably selected to avoid impacting production of the relevant substrate material.

Preferably, the aforementioned sheet-fed rotary printing press 100, 200, 300 can be provided with a sheet transfer drum located at an in-feed section of the sheet-fed rotary printing press 100, 200, 300, which sheet transfer drum is driven into rotation at a varying circumferential speed to ensure appropriate transfer of the individual sheets from the sheet feeder group 102, 202, 302 to the printing group 101, 201, 301 of the press.

Various modifications and/or improvements may be made to the above-described embodiments without departing from the scope of the invention as defined by the annexed claims. For instance, while embodiments of offset, intaglio and letterpress printing presses have been described, the invention is equally applicable to any printing presses commonly used in the context of the production of banknotes (and like securities), including screen printing presses, flexographic printing presses, and hot-stamping presses.

### LIST OF REFERENCE NUMERALS USED THEREIN (IF ANY)

S individual (printed) sheets
E effective printed area of the sheets/matrix arrangement of rows and columns of imprints P
P imprints on effective printed area E of the sheets S
L sheet length (parallel to the direction of printing)
W sheet width (transversely to the direction of printing)
S⁰ inspected sheets carrying only good imprints/entirely good sheets
S′ inspected sheets carrying mixture of good imprints and defective imprints/partially defective sheets
S^{X} inspected sheets carrying only defective imprints/entirely defective sheets
NB note bundle(s) (e.g. banknote bundle(s))
PNB pack(s) of note bundles 210
B paper (or like substrate) web for the production of security paper
BW₀ width of paper (substrate) web (e.g. approx. 2500 mm)
B1 (first) individual web (derived from web B) for the production of super-format sheets
B2 (second) individual web (derived from web B) for the production of super-format sheets
B3 (third) individual web (derived from web B) for the production of super-format sheets
BW width of individual webs B1, B2, B3 (e.g. approx. 835 mm)
B1* (first) individual web (derived from web B) for the production of large-format sheets
B2* (second) individual web (derived from web B) for the production of large-format sheets
BW* width of individual webs B1*, B2* (e.g. approx. 1250 mm)
C cylinder
D nominal diameter of cylinder C
SL segment length of each segment of cylinder C
GL gap length between each cylinder segment of cylinder C
AL axial length of cylinder C
100 simultaneous recto-verso (“Simultan”) offset printing press
101 printing group of printing press 100
102 sheet feeder group of printing press 100
103a sheet transfer cylinder (one-segment cylinder)
103b sheet transfer cylinder (two-segment cylinder)
103c sheet transfer cylinder (one-segment cylinder)
104 drying/curing unit
110 (first) blanket cylinder (three-segment cylinder)
115 (four) plate cylinders (one-segment cylinders)
115a cylinder gap of plate cylinder(s) 115
120 (second) blanket cylinder (three-segment cylinder)
125 (four plate cylinders (one-segment cylinders)
125a cylinder gap of plate cylinder(s) 125
131 (four) inking devices
132 (four) inking devices
150 pair of side frames supporting blanket cylinders 110, 120
151 (first) mobile inking carriage supporting inking device 131
151* mobile inking carriage 151 in retracted position
152 (second) mobile inking carriage supporting inking devices 132
152* mobile inking carriage 152 in retracted position
160 sheet transporting system (with spaced-apart gripper bars)
180 sheet delivery station
200 five-colour indirect (“Orlof”) intaglio printing press
201 printing group of printing press 200
202 sheet feeder group of printing press 200
210 impression cylinder (three-segment cylinder)
215 plate cylinder (three-segment cylinder)
220 ink-collecting (“Orlof”) cylinder (three-segment cylinder)
230 (five) inking devices
231 ink ducts
232 pair of ink-application rollers
233 (five) chablon cylinders (one-segment cylinders)
240 ink wiping system
250 pair of side frames supporting impression cylinder 210 and plate cylinder 215
251 intermediate mobile carriage supporting ink-collecting cylinder 220 and chablon cylinders 233
252 mobile inking carriage supporting inking devices 230
252* mobile inking carriage 252 in retracted position
260 sheet transporting system (with spaced-apart gripper bars)
280 sheet delivery station
300 letterpress printing (numbering) press
301 printing group of printing press 300
302 sheet feeder group of printing press 300
310 impression cylinder (two-segment cylinder)
315 (two) letterpress printing cylinders (one-segment cylinders)/numbering cylinders carrying numbering boxes
325 letterpress printing cylinder (one-segment cylinder)
330 (three) inking devices
350 pair of side frames supporting impression cylinder 310 and letterpress printing cylinders 315, 325
351 mobile inking carriage supporting inking devices 330
351* mobile inking carriage 351 in retracted position
360 sheet transporting system (with spaced-apart gripper bars)
380 sheet delivery station

1. A sheet-fed rotary printing press for the production of banknotes and like securities comprising at least one printing form cylinder having one or more segments,
wherein a nominal diameter of the at least one printing form cylinder substantially corresponds to an integer multiple of a reference diameter of a one-segment cylinder as used for printing onto super-format sheets exhibiting a standardized format with a width of the order of 820 mm and a length of the order of 700 mm,
and wherein an axial length of the at least one printing form cylinder is comparatively greater than a nominal axial length of a corresponding printing form cylinder as used for printing onto super-format sheets, by an amount such that the at least one printing form cylinder is suitable for printing onto large-format sheets having a comparatively greater width than the width of super-format sheets.

2. The sheet-fed rotary printing press according to claim 1, wherein a circumferential length of each segment of the at least one printing form cylinder is comparatively greater than a nominal circumferential length of each segment of a corresponding printing form cylinder as used for printing onto super-format sheets, by an amount such that the at least one printing form cylinder is suitable for printing onto large-format sheets having a comparatively greater length than the length of super-format sheets.

3. The sheet-fed rotary printing press according to claim 1, further comprising side frames supporting the at least one printing form cylinder, which side frames are common to corresponding sheet-fed rotary printing presses used for printing onto super-format sheets exhibiting the same printing cylinder arrangement.

4. The sheet-fed rotary printing press according to claim 1, wherein the axial length of the at least one printing form cylinder is suitable for printing onto large-format sheets having a width of 1200 mm or more.

5. The sheet-fed rotary printing press according to claim 4, wherein the axial length of the at least one printing form cylinder is suitable for printing onto large-format sheets having a width of 1240 mm to 1250 mm.

6. The sheet-fed rotary printing press according to claim 4, wherein the width of the large-format sheets substantially corresponds to an integer fraction of a width of a substrate web as produced by paper mills or like substrate manufacturers.

7. The sheet-fed rotary printing press according to claim 6, wherein the width of the large-format sheets substantially corresponds to half the width of the substrate web.

8. The sheet-fed rotary printing press according to claim 2, wherein the circumferential length of each segment of the at least one printing form cylinder is suitable for printing onto large-format sheets having a length which is comprised between 700 mm and 850 mm.

9. The sheet-fed rotary printing press according to claim 8, wherein the circumferential length of each segment of the at least one printing form cylinder is suitable for printing onto large-format sheets having a length which is of the order of 720 mm to 800 mm.

10. The sheet-fed rotary printing press according to claim 1, wherein the sheet-fed rotary printing press is an offset printing press including multiple plate cylinders acting as printing form cylinders.

11. The sheet-fed rotary printing press according to claim 10, wherein the sheet-fed rotary printing press is a simultaneous recto-verso offset printing press comprising a pair of mutually-cooperating blanket cylinders, which blanket cylinders each collect multiple ink patterns from the multiple plate cylinders in the form of multicolour ink patterns and transfer the multicolour ink patterns simultaneously on recto and verso sides of the sheets.

12. The sheet-fed rotary printing press according to claim 10, wherein the multiple plate cylinders each consist of a one-segment plate cylinder having a nominal diameter of the order of 280 mm.

13. The sheet-fed rotary printing press according to claim 10, wherein the multiple plate cylinders each cooperate with a three-segment blanket cylinder having a nominal diameter of the order of 840 mm.

14. The sheet-fed rotary printing press according to claim 1, wherein the sheet-fed rotary printing press is an intaglio printing press comprising a plate cylinder acting as printing form cylinder, which plate cylinder cooperates with an impression cylinder.

15. The sheet-fed rotary printing press according to claim 14, wherein the sheet-fed rotary printing press is an Orlof intaglio printing press comprising an ink-collecting cylinder cooperating with the plate cylinder, which ink-collecting cylinder collects multiple ink patterns in the form of a multicolour ink pattern and transfers the multicolour ink pattern onto the plate cylinder.

16. The sheet-fed rotary printing press according to claim 14, wherein the plate cylinder consists of a three-segment plate cylinder having a nominal diameter of the order of 840 mm, which three-segment plate cylinder is inked directly and/or indirectly by means of one or more chablon cylinders having a nominal diameter of the order of 280 mm.

17. The sheet-fed rotary printing press according to claim 1, wherein the sheet-fed rotary printing press is a letterpress printing press comprising at least one letterpress cylinder acting as printing form cylinder, which at least one letterpress cylinder cooperates with an impression cylinder.

18. The sheet-fed rotary printing press according to claim 17, wherein the sheet-fed rotary printing press is a numbering press comprising two numbering cylinders acting as letterpress cylinders, which two numbering cylinders cooperate with one and the same impression cylinder.

19. The sheet-fed rotary printing press according to claim 17, wherein each letterpress cylinder consists of a one-segment letterpress cylinder having a nominal diameter of the order of 374 mm.

20. The sheet-fed rotary printing press according to claim 17, wherein the impression cylinder consists of a two-segment impression cylinder having a nominal diameter of the order of 748 mm.

21. The sheet-fed rotary printing press according to claim 1, further comprising a sheet transfer drum located at an in-feed section of the sheet-fed rotary printing press, which sheet transfer drum is driven into rotation at a varying circumferential speed to ensure transfer of individual sheets from a sheet feeder group to a printing group of the sheet-fed rotary printing press.
